(19) United States
(12) Patent Application Publication
(10) Pub. No.: US 2008/0301781 A1
(43) Pub. Date: Dec. 4, 2008

(54) METHOD, SYSTEM AND COMPUTER PROGRAM FOR MANAGING MULTIPLE ROLE USERID

(75) Inventors: Filomena Ferrara, Roma (IT); Scol MacLellan, Roma (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/131,232

(22) Filed: Jun. 2, 2008

(30) Foreign Application Priority Data
Jun. 4, 2007 (EP) 07109478.3

(51) Int. Cl. H04L 9/32

(52) U.S. Cl. 726/4

(57) ABSTRACT

In a data processing system it is necessary to make sure that only authorized users have access to system resources and normally not all the users can have access to all and to the same resources. The present invention provides a method and a system for controlling resources, handling multiple authorization roles with a single userID, and allows for movement between the roles without changing identity. This results in a clearer audit trail, and removes the need for extensive knowledge of the security system commands and for multiple steps to allow a step up or down in authorization.

### FIELD OF THE INVENTION

The present invention relates to the information technology field. More specifically, the invention relates to the management of user IDs having a plurality of possible different roles.

### BACKGROUND ART

In a data processing system which controls a plurality of resources it is necessary to make sure that only authorized users have access to system resources and normally not all the users can have access to all and to the same resources. It is known to create user profiles to which a predetermined set of authorizations is associated. Access to software resources is generally controlled by security software that grants or prevents access based on two main access control themes: authentication and authorization. Authentication verifies whether or not a person is who he claims to be, through methods such as checking userID/password combinations or similar. When a user fails authentication checks, he is generally prevented from accessing any of the systems. When a user is authenticated, then he may access a pre-determined subset of the system resources, based on authorization rights. Authorization defines what an authenticated user is allowed to do in a system. Authorization may define tasks that a user is allowed to execute, it may define a subset of resources that a user may work with, or it may be a combination of the two.

System administrators (or system programmers) require extensive authorization rights in order to perform priviledged operations to configure and maintain the systems. Working at the administrator level of authorization requires extreme care, as the results of an inadvertent mistake could be extremely costly. As a result, best practices dicatate that administrators perform ‘normal’ operations with the authorization granted to a ‘normal’ userID, and log off and then on again with an ‘administrator’ id when a higher level of authorization is required. This approach requires that multiple userIDs are assigned to users that require different roles. An alternative is to run with a priviledged id in terms of the commands that can be executed, but with a low default level of authorization in terms of scope, and granting oneself priviledges when required to perform specific operations on specific resources.

An example of state of the art system is the Resource Access Control Facility (RACF) by International Business Machines Corp. With this system, each userID has a single authorization scope, defined by the combination of permissions for the group(s) to which the userID belongs, and permissions assigned to the individual userID. Even if permissions can be inherited from different groups, the resultant permission set is static, and is always assigned to the userID when it logs onto the system. Each userID has a single password. Users with a high degree of authorization (e.g. systems programmers) will often maintain two userIDs, one for doing ‘normal’ operations as an end user, and the other for when certain permissions are really required. Using the ‘normal’ userID for normal operations ensures that system damage will not result from mistakes or oversights. When the high-priviledge userID is used, extra caution is taken. Another method that is used to defend from costly mistakes is to maintain the permissions to a minimum, but to authorize a user to execute a command (TSO PERMIT) to grant permissions to themselves only when needed. This technique is used by trusted users to defend themselves from potential errors or oversights.

Another example is UNIX standard security systems which allow a single authorization profile per userID. Even users that have authorization to the ROOT userID will refrain from using it unless necessary for the job at hand. Usually they will log on with their normal userID and ‘upgrade’ their priviledges using the Switch User (SU) to gain ROOT priviledges for the time that is necessary. At this point however the user switches identity from their normal login to ROOT.

A drawback of the solutions described above is that they require additional overhead and level of indirection in audit trails, and they are also rather error-prone and requires multiple steps for every operation.

It is an object of the present invention to provide a solution which overcome the above drawback of the prior art.

### SUMMARY OF THE INVENTION

The present invention provides a solution as set out in the independent claims. Advantageous embodiments of the invention are described in the dependent claims.

According to the present invention, we provide a method for controlling user access to a plurality of resources in a data processing system, the data processing system maintaining a set of stored userIDs each userID having a plurality of associated stored passwords, each password being coupled to a predetermined profile defining a set of resource access authorizations, the method including the steps of: prompting a user to input a userID; prompting the user to input a first password; scanning the stored userIDs and the associated stored passwords to identify a match with the input userID and first password; responsive to a match being identified selectively granting the user access to the resources according to the predetermined profile coupled to the input first password.

Another aspect of the invention proposes a computer program for performing the method.

A further aspect of the invention proposes a corresponding system.

### REFERENCE TO THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1 is a schematic block diagram of a data processing system in which the solution according to an embodiment of the invention is applicable;

FIG. 2 shows the functional blocks of an exemplary computer of the system;

FIG. 3 depicts the main software components that can be used to practice the solution according to an embodiment of the invention; and

FIG. 4 shows a diagram describing the flow of activities relating to an implementation of the solution according to an embodiment of the invention.

### DETAILED DESCRIPTION

The present invention provides a method to associate multiple authorization roles with a single userID, and allows for movement between the roles without changing identity. This results in a clearer audit trail, and removes the need for extensive knowledge of the security system commands and for multiple steps to allow a step up or down in authorization.

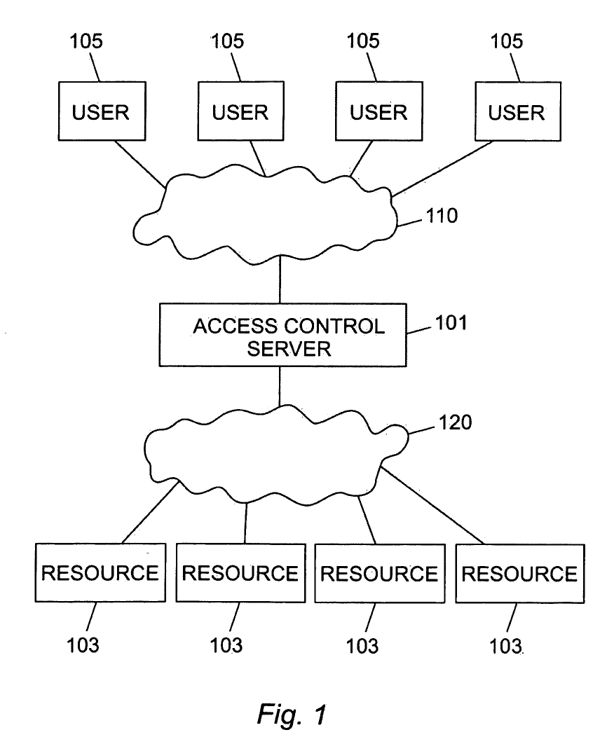

With reference in particular to FIG. 1, a data processing system is depicted. The system includes a Control Access Server 101 which controls a plurality of resources 103 through communications means 120 (e.g. a network or the Internet); users can request the access to resources 103 through clients 105 which are connected to the server 101 by means of a network 110. Server 101 controls the access to the resources 103 according to predetermined authorization levels associated to a plurality of roles.

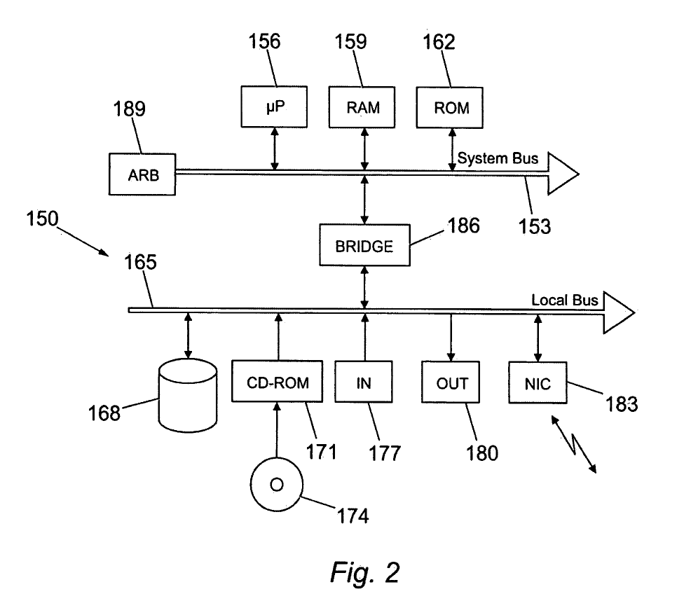

Considering now FIG. 2, a generic computer of the above-described system (Access Control Server, clients, resources) is denoted with 150. The computer 150 is formed by several units that are connected in parallel to a system bus 153 (with a structure that is suitably scaled according to the actual function of the computer 150 in the system) . In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass storage consists of one or more hard-disks 168 and a drive 171 for reading CD-ROMs 174. Moreover, the computer 150 includes input units 177 (for example, a keyboard and a mouse), and output units 180 (for example, a monitor and a printer) . A network adapter 183 is used to plug the computer 150 into the system. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

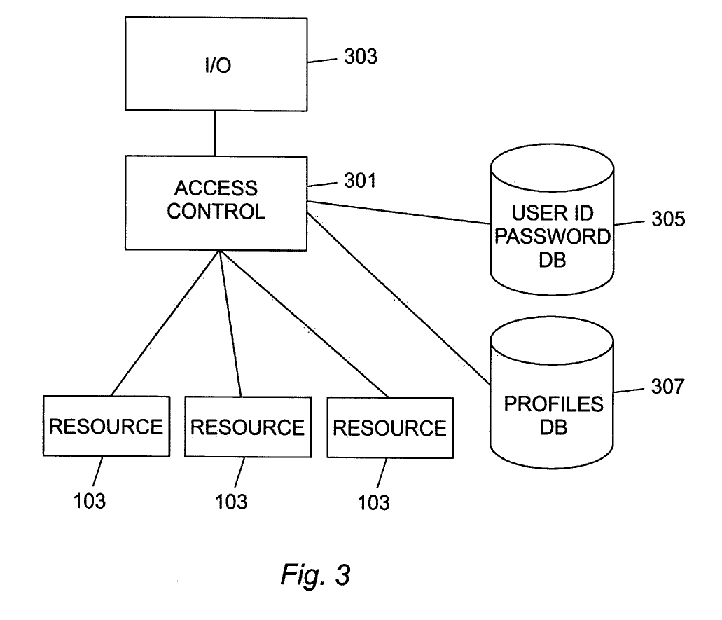

Moving to FIG. 3, the main software components that run on the above-described system are represented. The information (programs and data) is typically stored on the hard-disk and loaded (at least partially) into the working memory of each computer when the programs are running. The programs are initially installed onto the hard disk, for example, from CD-ROM.

The module Access Control 301 includes a software (e.g. RACF of International Business Machines Corp described above) which manages all access requests arriving from the I/O module 303. When a new request is received, the user is prompted to enter the userID and the corresponding password. The Access Control module looks for the userID/password pair on the database 305 and associates the corresponding profile contained in database 307, where all the authorization levels associated to such profile are defined. According to the associated profile, access to the resources 103 is granted or denied. The resources can be any kind of physical or logic objects which can be controlled by a data processing system: just to make a few examples a resource can be a file, a directory, a peripheral HW device, a data base, a SW application. Also the kind of possible authorizations can have a wide variety of different implementations: e.g. it could be a simple permission to read, write or execute a file, or to use a resource, or to perform an action; another possibility is that a file or a resource could be “visible” only to some users and hidden to all the other users. It is often the case that a privileged user, called Administrator can see and access all resources and perform any possible actions. Those skilled in the art will appreciate that many different alternative implementations are possible, e.g. the information on userID/password and the corresponding profile, could be stored in the same database or could be e.g. stored in the working memory of the data processing system.

According to a preferred embodiment of the present invention, the security system allows for multiple authorization roles to be assigned to a single user. According to a preferred embodiment of the present invention, these roles are mutually exclusive at any given time (i.e. on OR and not in AND), however different implementations are possible. Each role (profile) is associated to a different password. The passwords for each role follow a different lifecycle and may be subject to different rules, although, clearly, the password for each role must be different from the others in any instant. When a user logs on to a system, he chooses the role with which to access the system based on which of the active passwords is entered. The authentication system checks the entered password with each of the valid passwords for the userID in turn, and when a match is found the corresponding authorization role is applied. Once logged onto a system with a particular role, a user may change role by executing a command that re-authenticates the user and which re-assigns the authorization role based on the password entered.

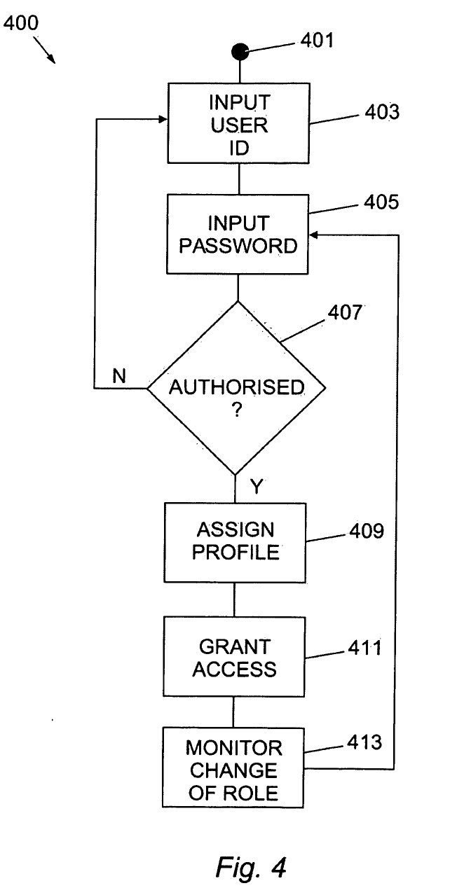

With reference now to FIG. 4, the logic flow of an exemplary process that can be implemented in the above-described system is represented with a method 400. The method 400 begins at the black start circle 401. At step 403 the userID is received by the system, e.g. entered by a user, while at step 405 the password is input. The pair userID and password is verified at step 407 to see if a match exists in the system. If it does not exist, the access is denied and the control goes back to step 403. If the password is valid and it matches with the userID, the system assigns the role and the corresponding profile to that user (step 409) and gives access to the system resources (step 411). As explained above the resources the user can access and the authorization the user receives are related to the assigned profile (which depends on the selected role) . The system then monitors a possible request by the user for a change of role and of the corresponding profile (step 413): when such a request is received the control goes back to step 405 where a new password is entered but the userID is maintained.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply if the system has a different architecture or includes equivalent units; for example, the resources could be physically placed on the same data base. Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

Without departing from the principles of the invention, it is also possible to exploit equivalent structures only dedicated to this purpose.

It should be readily apparent that the implementation of the present invention is not limited to any specific application and/or technique for verifying the userID and the password; for example, it is possible to use other Access Control applications and to implement different user access policies.

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media) . Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code) . Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for controlling user access to a plurality of resources in a data processing system, the data processing system maintaining a set of stored userIDs each userID having a plurality of associated stored passwords, each password being coupled to a predetermined profile defining a set of resource access authorizations, the method including the steps of:
prompting a user to input a userID;
prompting the user to input a first password;
scanning the stored userIDs and the associated stored passwords to identify a match with the input userID and first password;
responsive to a match being identified selectively granting the user access to the resources according to the predetermined profile coupled to the input first password.

2. The method according to claim 1 wherein the step of scanning includes:
scanning the stored userIDs to identify a first match with the input userID;
responsive to the first match being identified, scanning the stored passwords associated to the input userID to identify a second match with the input first password;
and wherein the step of granting access is responsive to the second match being identified.

3. The method of claim 1 wherein the resource access authorizations include authorizations for performing a predetermined set of user actions.

4. The method of claim 1 wherein one of the profiles includes authorization to access any of the plurality of resources and the authorization of performing any possible user actions.

5. The method of claim 1 further comprising the steps of:
responsive to a user request, prompting the user to input a second password;
scanning the stored passwords associated to the input userID to identify a third match with the input second password;
modifying the user access authorizations. to the resources according to the predetermined profile coupled to the input second password.

6. The method of claim 1 further including the steps of:
responsive to any of the scanning step not identifying a match with the user input userID or with the user input password, preventing the user to access, any of the resources; and
prompting the user to re-enter the userID and the password.

7. A computer program in a computer readable medium for performing the method for controlling user access to a plurality of resources in a data processing system when the computer program is executed on a data processing system, the data processing system maintaining a set of stored userIDs each userID having a plurality of associated stored passwords, each password being coupled to a predetermined profile defining a set of resource access authorizations, the method including the steps of:
prompting a user to input a userID;
prompting the user to input a first password;
scanning the stored userIDs and the associated stored passwords to identify a match with the input userID and first password;
responsive to a match being identified selectively granting the user access to the resources according to the predetermined profile coupled to the input first password.

8. (canceled)

9. A system method for controlling user access to a plurality of resources in a data processing system the data processing system maintaining a set of stored userIDs each userID having a plurality of associated. stored passwords, each password being coupled to a predetermined profile defining a set of resource access authorizations, comprising:
means for—prompting a user to input a userID;
means for—prompting the user to input a first password;
means for—scanning the stored userIDs and the associated stored passwords to identify a match with the input userID and first password;
means for—responsive to a match being identified selectively granting the user access to the resources according to the predetermined profile coupled to the input first password.

10. (canceled)
